(19) United States
(12) Patent Application Publication
(10) Pub. No.: US 2011/0070346 A1
(43) Pub. Date: Mar. 24, 2011

(54) INTEGRAL INTERVENTION SYSTEM

(75) Inventors: WAYNE SPILLNER, Warrenton, VA (US); Lee Clarkson, Amissville, VA (US); Charlie Degges, Manassas, VA (US); James Spisich, Culpeper, VA (US)

(73) Assignee: Ross Industries, Inc., Midland, VA (US)

(21) Appl. No.: 12/889,081

(22) Filed: Sep. 23, 2010

Related U.S. Application Data
(60) Provisional application No. 61/245,558, filed on Sep. 24, 2009.

(51) Int. Cl. A23L 3/3454; A23P 1/08

(52) U.S. Cl. 426/281; 99/450.1; 99/516

(57) ABSTRACT

An intervention system for treating a food product in a food conditioner. The system comprises a tank that receives and buffers an intervention solution from a mixing system, a pump that receives the intervention solution from the tank and pressurizes the intervention solution to output a pressurized intervention solution, a flow monitor that receives the pressurized intervention solution from the pump and monitors a predetermined characteristic of the pressurized intervention solution, a first applicator that receives a first portion of the pressurized intervention solution from the flow monitor and ejects a first mist in the direction of the food product, and a second applicator that receives a second portion of the pressurized intervention solution from the flow monitor and ejects a second mist in the direction of the food product.

### CROSS REFERENCE TO PRIOR APPLICATIONS

This application claims priority under 35 U.S.C. §119(e) to U.S. Provisional Patent Application No. 61/245,558, filed Sep. 24, 2009, and titled “Integral Intervention System and Method for Tenderizer,” the disclosure of which is expressly incorporated by reference herein in its entirety.

### FIELD OF THE DISCLOSURE

The present disclosure relates to an apparatus, a system and a method for delivering and/or applying an intervention solution to meat products, such as, for example, meat, poultry, pork, fish, vegetables, fruits, and the like.

### BACKGROUND OF THE DISCLOSURE

As of the date of this writing, the U.S. Department of Agriculture (USDA) recognized four separate processes for processing meat products such as meat and poultry that are deemed to deliver more tender and flavorful non-intact products for the consumer. The recognized processes include the use of mechanical blade tenderizers that cut through sinew and connective tissue, masceration (or cubing), injection and marination.

Contaminated non-intact meat products have been deemed to be the cause of various food poisoning outbreaks and product recalls in the past. The presence of pathogens on the surface of the meat products can cause food safety risks to consumers, as well as accelerate spoilage. These pathogens may be carried from one portion of a meat product to another portion of the same or a different meat product by cross-contamination, for example, when injectors or marinaders re-circulate liquid from the portion of the meat product to the other portion of the same or a different product. Mechanical tenderizers such as, for example, cubers or blade tenderizers appear to be less susceptible to cross-contamination of food borne pathogens.

The present disclosure provides an apparatus, a system and a method for delivering and applying an intervention solution to meat products, including, for example, meat, poultry, pork, fish, vegetables, fruits, and the like, to minimize food borne illnesses resulting from pathogens on processed food products.

### SUMMARY OF THE DISCLOSURE

According to an aspect of the disclosure, an intervention system is disclosed for treating a food product in a food conditioner. The system comprises: a tank that receives and buffers an intervention solution from a mixing system; a pump that receives the intervention solution from the tank and pressurizes the intervention solution to output a pressurized intervention solution; a flow monitor that receives the pressurized intervention solution from the pump and monitors a predetermined characteristic of the pressurized intervention solution; a first applicator that receives a first portion of the pressurized intervention solution from the flow monitor and ejects a first mist in the direction of the food product; and a second applicator that receives a second portion of the pressurized intervention solution from the flow monitor and ejects a second mist in the direction of the food product.

The predetermined characteristic may include a rate of flow of the pressurized intervention solution.

The pump may comprise at least one of: a positive displacement pump; an electric Santoprene™ diaphragm pump; or an air-operated twin diaphragm pump.

The first applicator may comprise: a nozzle that ejects the first mist in the direction of the food product; and a first supply line that supplies the intervention solution to the nozzle that ejects the first mist. The first applicator may further comprise: another nozzle that ejects another mist in the direction of the food product; a further nozzle that ejects a further mist in the direction of the food product; and a second supply line that supplies the intervention solution to said another nozzle. The first mist, the second mist, the other mist, and the further mist may be configured to overlap and collectively form a spray curtain that substantially envelopes the food product and substantially contain any overspray within a processing chamber of the food conditioner.

The second applicator may comprise: a nozzle that ejects the second mist in the direction of the food product; and a supply line that supplies the intervention solution to the nozzle that ejects the second mist. The nozzle may be affixed to the first supply line; the other nozzle may be affixed to the second supply line; and the first supply line may be substantially parallel to the second supply line. The second applicator may further comprise: another nozzle that ejects another mist in the direction of the food product; and a further nozzle that ejects a further mist in the direction of the food product, wherein the nozzle, the other nozzle, and the further nozzle may be configured such that the second mist, the other mist, and the further mist are offset from each other.

The intervention system may further comprise a balance valve that controls a rate of ejection of the second portion of the pressurized intervention solution with regard to a rate of ejection of the first portion of the pressurized intervention solution, thereby balancing treatment of the food product by the first mist and the second mist to substantially fully coat an external surface area of the food product.

The intervention system may further comprise a level sensor that monitors a level of the intervention solution in the tank.

The food conditioner that comprises the intervention system may comprise: a meat tenderizer; a cuber; a tender press; a rinser; a washer; a slicer; or an injector.

According to a further aspect of the disclosure, an intervention system is disclosed for a food conditioner. The intervention system comprises: a first applicator that is configured to apply a pressurized intervention solution to a first surface area of a food product; a second applicator that is configured to apply the pressurized intervention solution to a second surface area of the food product, wherein an entire surface area of the food product substantially consists of the first surface area and the second surface area.

The first applicator may comprise: a nozzle that ejects a first mist in the direction of the first area of the food product; and a first supply line that supplies the intervention solution to the nozzle that ejects the first mist. The first applicator may further comprise: another nozzle that ejects another mist in the direction of the food product; and a second supply line that supplies the intervention solution to said another nozzle. The nozzle may be affixed to the first supply line; the other nozzle may be affixed to the second supply line; and the first supply line may be substantially parallel to the second supply line.

The second applicator may comprise: a nozzle that ejects a second mist in the direction of the second surface area of the food product; and a supply line that supplies the intervention solution to the nozzle that ejects the second mist. The second applicator may comprise: another nozzle that ejects another mist in the direction of the food product; and a further nozzle that ejects a further mist in the direction of the food product, wherein the nozzle, the other nozzle, and the further nozzle may be configured such that the second mist, the other mist, and the further mist are offset from each other

The intervention system may further comprise a pump that pressurizes an intervention solution to generate the pressurized intervention solution.

The intervention system may further comprise a tank that receives and buffers the intervention solution from a mixing system before supplying a buffered intervention solution to the pump.

According to a still further aspect of the disclosure, a method is disclosed for treating a food product. The method comprises: receiving an intervention solution; buffering the received intervention solution to output a buffered intervention solution; pressurizing the buffered intervention solution to output a pressurized intervention solution; applying the pressurized intervention solution to the food product; collecting an effluent from the food product; and discarding substantially all of the effluent. The intervention solution may include a blended intervention solution that is received from a central mixing system which in-line mixes a plurality of intervention solution concentrates with water to generate the blended intervention solution.

Additional features, advantages, and embodiments of the disclosure may be set forth or apparent from consideration of the following attached detailed description and drawings. Moreover, it is to be understood that both the foregoing summary of the disclosure and the following attached detailed description are exemplary and intended to provide further explanation without limiting the scope of the invention as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a food conditioner, which may include an integral intervention system that is constructed according to the principles of the disclosure;

FIG. 2 shows a perspective view of an example of an intervention solution application system that is constructed according to the principles of the disclosure;

FIG. 3 shows a top view of the intervention solution application system of FIG. 2;

FIG. 4 shows a side view of the intervention solution application system of FIG. 2;

FIG. 5 shows an example of an intervention system, which is constructed according to the principles of the disclosure;

FIG. 6 shows an example of a mixing system, which is constructed according to the principles of the disclosure;

FIG. 7 shows another example of a mixing system, which is constructed according to the principles of the disclosure;

FIG. 8 shows an example of an integral intervention system, which is constructed according to the principles of the disclosure;

FIG. 9 shows another example of an integral intervention system, which is constructed according to the principles of the disclosure;

FIG. 10 shows yet another example of an integral intervention system, which is constructed according to the principles of the disclosure; and

FIG. 11 shows an example of a process flow for applying an intervention solution to a food product, according to the principles of the disclosure.

The present disclosure is further described in the detailed description that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings, and detailed in the following attached description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a programmable logic controller (PLC), a motion controller, a processor, relay logic, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a smart telephone, a cellular telephone device, a satellite telephone device, a cordless telephone, a software defined radio (SDR), a two-way radio, a personal data assistant (PDA), a mobile computer, a stationary computer, mobile station, a game console, a game controller, user equipment, or the like.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a field bus topology, a bus topology, a linear bus topology, a distributed bus topology, a star topology, an extended star topology, a distributed star topology, a ring topology, a mesh topology, a tree topology, or the like.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a compact flash card, a thumb drive, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

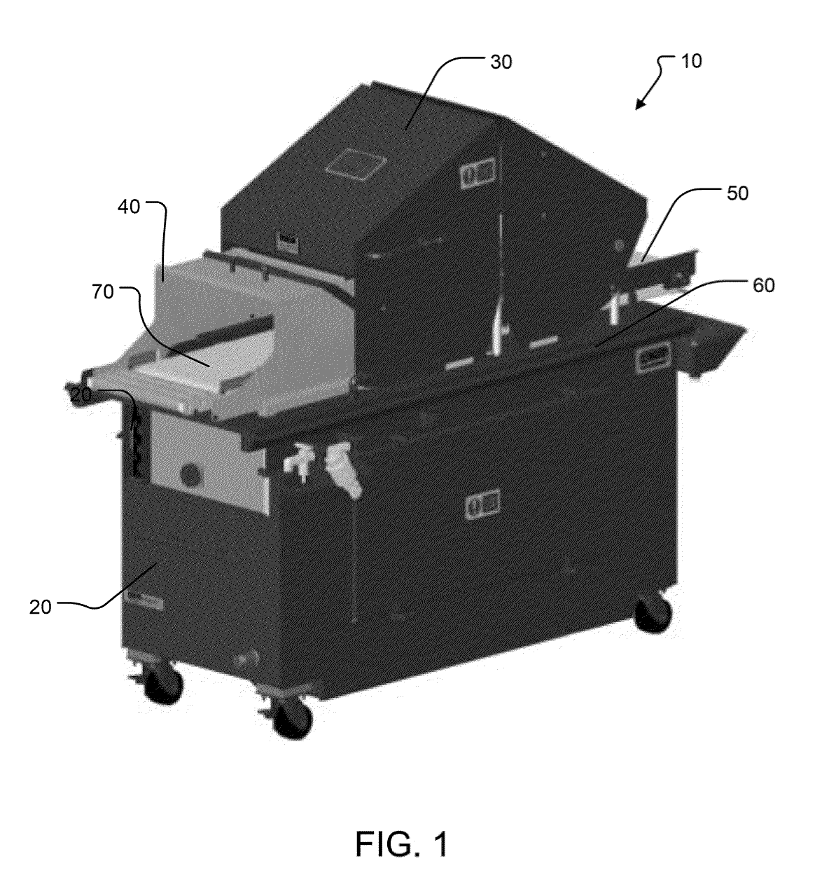

FIG. 1 shows an example of a food conditioner 10, which may include an intervention system that is constructed according to the principles of the disclosure. The food conditioner 10 may include a device that conditions or further processes food products (for example, non-intact meat and poultry products), such as, for example, a mechanical blade tenderizer, a cuber, a tender press, an injector, a rinser, a washer, a slicer, or the like. The food conditioner 10 comprises a housing 20, a food product processor 30, an output chute 40, an input portion 50, an effluent channel 60, and a conveyor 70. The food product processor 30 may include a tenderizer (not shown) that is configured to tenderize food products (not shown), including, for example, poultry, beef, pork, and the like. Alternatively, the food product processor 30 may include a cuber, a press, or the like, for processing the food products. The conveyor 70 may include, for example, a stainless steel mesh belt, or the like, that allows fluid to flow substantially freely there-through. The conveyor 70 is configured to transport a food product from the input portion 50, through the food product processor 30 and to the output chute of the food conditioner 10. The food conditioner 10 includes an intervention solution application system that is configured to supply and apply an intervention solution to the food products during processing in the food product processor 30.

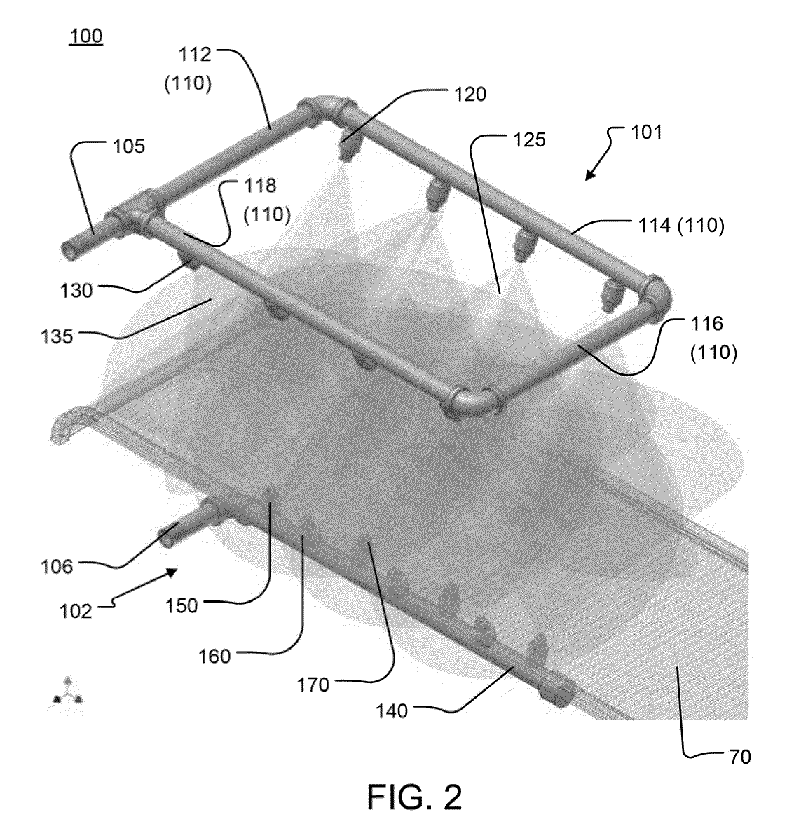

FIG. 2 shows a perspective view of an example of an intervention solution application system 100 that is constructed according to the principles of the disclosure. The intervention solution application system 100 may be implemented to apply an intervention solution to food products, including, for example, poultry, beef, pork, fish, and the like, or vegetables, fruits, and the like, as well as non-food products, as will be appreciated and understood by those having ordinary skill in the art.

The intervention solution application system 100 may include a first applicator 101 and a second applicator 102. The first applicator 101 may be configured to supply and apply an intervention solution to an upper (or lower) portion of the food product. The second applicator 102 may be configured to supply and apply an intervention solution to a lower (or upper) portion of the food product. Collectively, the first and second applicators 101, 102 may supply and apply the intervention solution to the entire surface of the food product for a total 360° application. The first applicator 101 and the second applicator 102 can operate effectively, as shown in FIG. 2, or if rotated by 90° to spray from the sides of the conveyor 70, instead of from above and below the conveyor 70.

The first and second applicators 101, 102 may be aligned across the conveyor 70, and, using, for example, a plurality of fan-pattern nozzles, the applicators 101, 102 may eject a plurality of overlapping, conical-shaped mist beams that overlap to create a spray containment curtain that envelopes the food product being treated and limits the area treated, so as to minimize waste of intervention solution, while facilitating a smaller processing chamber (not shown) in the food product processor 30 and a smaller guard(s) (not shown) at the opening(s) of the processing chamber. The guard(s) at the opening(s) of the processing chamber may form a wall, or a partial wall of the chamber. The spray containment curtain may effectively contain any overspray within the processing chamber and perimeter collection gutters (not shown) provided in (or near) the processing chamber.

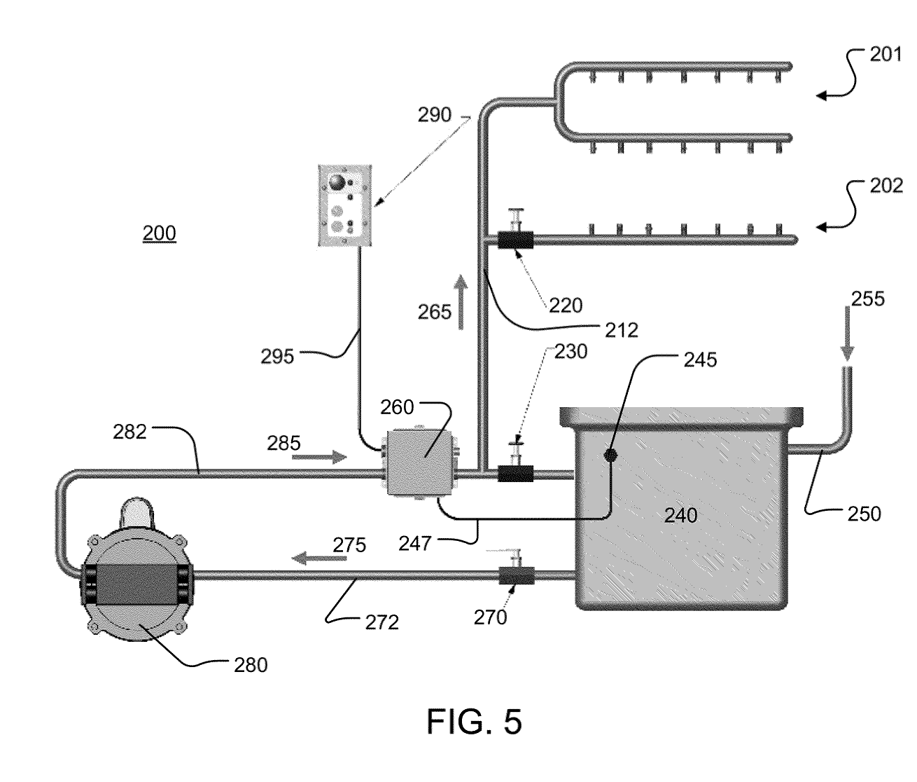

The first applicator 101 may include, for example, a source supply line 105, one or more supply lines 110, and a plurality of nozzles 120, 130. The source supply line 105 may be connected to a source that supplies a pressurized intervention solution (for example, a pump 280, shown in FIG. 5). The one or more supply lines 110 may include supply lines 112, 114, 116, 118. The plurality of nozzles 120, 130 may be affixed to, or integrally formed with the supply lines 110. As seen in FIG. 2, the plurality of nozzles 120 may be affixed to the supply line 114, and the plurality of nozzles 130 may be affixed to the supply line 118. The nozzles 120, 130 may be fixed and arranged to apply an intervention solution spray 125, 135 to an entire upper (or lower) surface of a food product. The spray beams 125, 135 may each have a conical-shaped pattern that overlaps on the surface of the food product as the food product is carried on the conveyor 70.

Alternatively, the nozzles 120, 130 may be configured to move under the control of a controller (for example, controller 290, shown in FIG. 5) to apply an intervention solution spray 125, 135, respectively, to different areas of a food product (not shown). For example, the nozzles 120, 130, may be configured to pivot or rotate with respect to the supply lines 110, so as to vary the area of the food product treated by the intervention solution sprays 125, 135.

Alternatively (or additionally), the supply lines 110 may be configured to rotate about their respective longitudinal axes, so as to vary the area of the food product treated by the intervention solution sprays 125, 135. For example, the supply line 114 may be configured to rotate around its longitudinal axis, thereby moving the nozzles 120 and the area treated by the spray 125 that is ejected from the nozzles 120. The supply line 118 may be configured similarly to the supply line 114 to move the nozzles 130 and the area treated by the spray 135 that is ejected from the nozzles 130.

It is noted that different ones of the plurality of nozzles 120 may be offset from each other to apply a respective spray 125 to different areas of the food product. Similarly, the plurality of nozzles 130 may also be offset from each other to apply a respective spray 135 to different areas of the food product.

While the example of FIG. 2 of the applicator 101 is shown as including four nozzles 120 and four nozzles 130, the applicator 101 may include any number of nozzles. Additional nozzles 120, 130 may be affixed to lines 112, 116, and/or lines 114, 118.

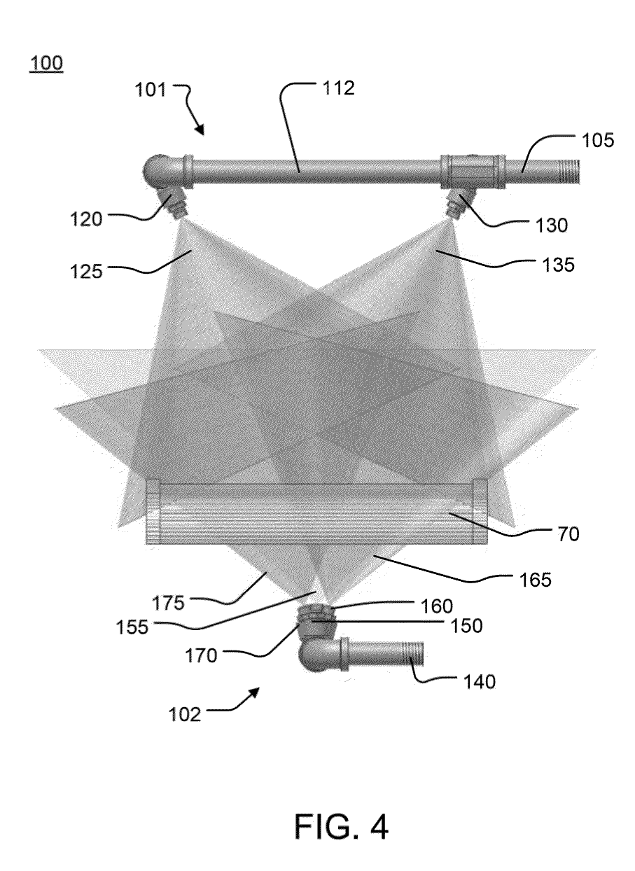

The second applicator 102 may include, for example, a source supply line 106, a supply line 140, and a plurality of nozzles 150, 160, 170. The source supply line 106 may also be connected to the source that supplies the pressurized intervention solution (for example, the pump 280, shown in FIG. 5). The plurality of nozzles 150, 160, 170 may be affixed to, or integrally formed with the supply line 140 and configured to eject a respective spray 155, 165, 175 in, for example, a cone pattern (shown in FIG. 4). As seen in FIG. 2, the nozzles 150, 160, 170 may be affixed to the supply line 140. The nozzles 150, 160, 170 may be fixed and offset from each other to apply an intervention solution spray 155, 165, 175, respectively, to three different areas of a lower (or upper) surface of the food product, with substantial overlap of the areas.

Alternatively, the nozzles 150, 160, 170 may be configured to move under the control of the controller to apply an intervention solution spray 155, 165, 175, respectively, to different areas of the food product. For example, one or more of the nozzles 150, 160, 170 may be configured to pivot or rotate with respect to the supply line 140, so as to vary the area of the food product treated by the intervention solution sprays 155, 165, 175. In this regard, fewer (or more) than three offset sets of nozzles 150, 160, 170 may be used to treat the entire surface of the lower portion of the food product. The spray beams 155, 165, 175 may have a conical-shaped pattern that overlaps on the surface of the food product as the food product is carried on the conveyor 70.

Alternatively (or additionally), the supply line 140 may be configured to rotate about its respective longitudinal axis, thereby moving the nozzles 150, 160, 170 and the area treated by the sprays 155, 165, 175 that are ejected from the nozzles 150, 160, 170.

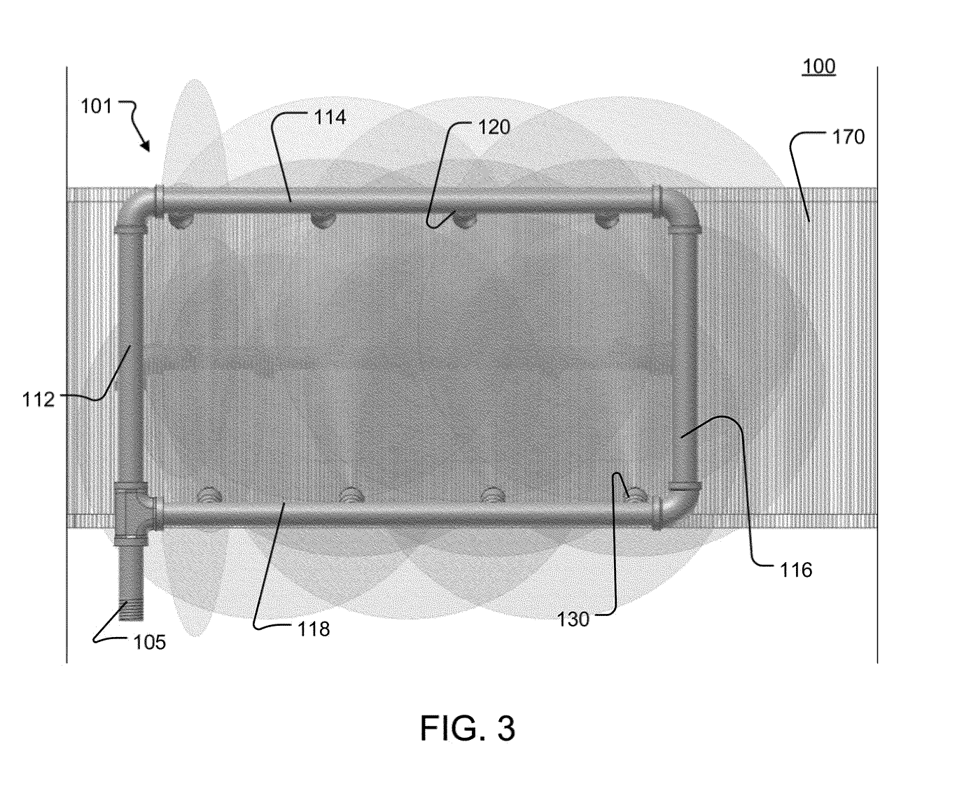

FIGS. 3 to 4 show various views of the intervention solution supply system 100. In particular, FIG. 3 shows a top view of the intervention solution supply system 100; and FIG. 4 shows a side view of the intervention solution supply system 100.

While the example of the applicator 101 shown in FIGS. 2-4 is shown as including a plurality of nozzles 120, 130 arranged in parallel along a pair of supply lines 114, 118, it is noted that the applicator 101 may include any number of nozzles 120, 130, as well as any number of supply lines 110 to which the nozzles 120, 130 may be attached or integrally formed with. The supply lines 110 may be arranged in a rectangular configuration (shown in FIGS. 2-4), a u-shape configuration (shown in FIG. 5), a ladder configuration (not shown), a circular configuration (not shown), or any other configuration, as understood by those having ordinary skill in the art. The number of nozzles 120 may be the same as, or different than the number of nozzles 130 provided in the applicator 101. The nozzles 120 may be positioned such that, for example, every other, or every third nozzle 120 is offset from the preceding one or two nozzles 120. The nozzles 130 may be similarly offset from each other.

Further, the applicator 101 may include any number of nozzles 150, 160, 170, as well as any number of supply lines 140 to which the nozzles 150, 160, 170 may be attached or integrally formed with. The supply line(s) 140 may be arranged in a single longitudinal configuration (shown in FIGS. 2-5), a rectangular configuration (for example, the applicator 101 shown in FIGS. 2-4), a u-shape configuration (for example, the applicator 201 shown in FIG. 5), a ladder configuration (not shown), a circular configuration (not shown), or any other configuration, as understood by those having ordinary skill in the art. The number of nozzles of any one of the sets of nozzles 150, 160, 170 may be the same as, or different than the number of the nozzles 150, 160, 170 in another or both of the other sets of the nozzles 150, 160, 170.

Furthermore, the applicator 101 may be located above the conveyor 70, and the applicator 102 may be located below the conveyor 70. Additional applicators (not shown) may be included that may be located along the sides of the conveyor 70. These additional applicators may be configured similarly to the applicator 101 or the applicator 102.

The nozzles 120, 130, 150, 160, 170 may include, for example a conical spray pattern misting nozzle, a linear spray pattern misting nozzle, or any other configuration of nozzle that, when used in the applicators 101, 102 will provide sufficient treatment of the entire surface (total 360° treatment) of the food product with the intervention solution. The nozzles 120, 130, 150, 160, 170 may be configured to operate, for example, at about 40 pounds-per-square-inch (psi).

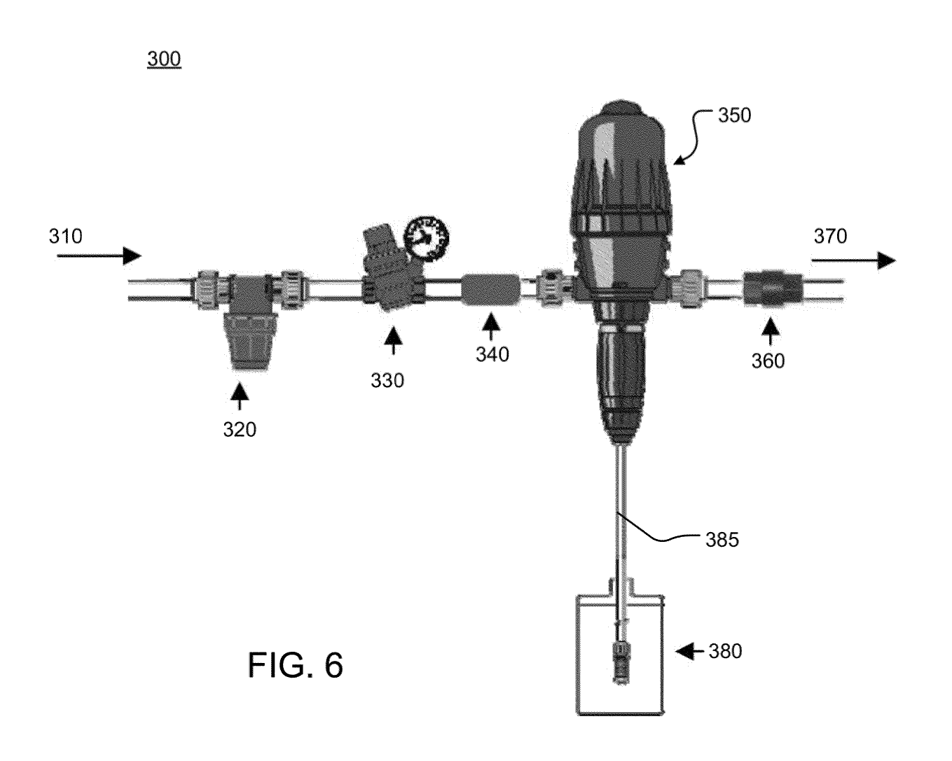

FIG. 5 shows an example of an intervention system 200, which is constructed according to the principles of the disclosure. The intervention system 200 includes a first applicator 201, a second applicator 202, a bypass valve 230, a tank 240, a source supply line 250, a flow monitor 260, a shut off valve 270, a pump 280, and a controller 290. The intervention system 200 may receive an intervention solution from a mixing system (for example, the mixing system 300, shown in FIG. 6) via the source supply line 250, where the intervention solution may flow into the tank 240 in a direction 255. The tank 240 may include a level sensor 245 that is configured to sense the level of the intervention solution in the tank 240 and ensure that fluid flow of the intervention solution is adequate for the volume of food products being treated and the rate at which the products are to be treated. It is noted that the mixing system may include any design that is configured to mix an intervention solution concentrate with water at a desired solution strength.

The inflow of intervention solution from the source supply line 250 to the tank 240 may be controlled on the basis of the level of the intervention solution detected by the level sensor 245. In this regard, the sensor 245 may be coupled to an inlet solenoid valve (not shown) via a communication link, which may be located between a mixing system (for example, mixing system 300 shown in FIG. 6) and the tank 240, to control the solenoid valve such that a sufficient amount of intervention solution is continuously provided to the tank 240. Alternatively (or additionally), the controller 290 may be connected to the solenoid valve via a communication link to control actuation of the solenoid valve to provide for an adequate amount of intervention solution to remain in the tank 240.

The intervention solution in the tank 240 may be supplied from the tank 240 to the pump 280 via the shut off valve 270 and the supply line 272. The intervention solution may flow in the direction of the arrow 275. The shut off valve 270 is configured to shut off the flow of intervention solution from the solution tank 240 to the pump 280. The pump 280 is configured to receive the buffered intervention solution from the tank 240 and supply a pressurized intervention solution to a supply line 282. The pump 280 may include, for example, a positive displacement pump, an electric Santoprene™ diaphragm pump, an air-operated twin diaphragm pump, or the like. The pump 280 may be interlocked to, for example, the drive (not shown) that drives the food processor 30 to prevent spraying of the intervention solution if the food conditioner 10 is non-operational, or disabled for servicing or maintenance. The pump 280 may have a fixed or variable flow rate for the system 200 to operate properly

The supply line 282 is in fluid communication with the flow monitor 260 and a supply line 212. The supply line 282 channels the pressurized intervention solution from the pump 280 to the supply line 212 in a direction 285. The flow monitor 260 may be located between the applicators 201, 202 and the pump 280, along the supply line 282. The flow monitor 260 is configured to monitor and regulate the rate of flow of the pressurized intervention solution in the supply line 282. The flow monitor 260 may be coupled to the controller 290 via a communication link 295.

The pressurized intervention solution in the supply line 212 may flow in the direction 265 to the applicators 201, 202. The pressurized intervention solution may be ejected from a plurality of nozzles in the applicators 201, 202 and sprayed on the entire surface of the food product (not shown). The applicator 202 may include a balance valve 220 to balance the amount of pressurized intervention solution applied to the food product by the applicator 202 with respect to the amount of pressurized intervention solution applied to the food product by the applicator 201, thereby providing a substantially uniform application of the intervention solution to the entire surface of the food product, including the top surface, the side surfaces and the bottom surface. The balance valve 220 may be manually controlled, or controlled by the controller 290. In the latter instance, a communication link may be provided between the controller 290 and the balance valve 220.

The bypass valve 220 is configured to open a fluid channel directly from the supply line 282 to the tank 240. The bypass valve 220 may be configured to be manually operated. Alternatively, the bypass valve 220 may be controlled by the controller 290, in which case a communication link may be provided between the controller 290 and the balance valve 220.

The controller 290 may include an ON/OFF switch with or without a computer (not shown).

FIG. 6 shows an example of a mixing system 300, which is constructed according to the principles of the disclosure. The mixing system 300 includes a water inlet 310, a filter 320, a pressure regulator 330, a flow restrictor 340, a mixer 350, a check valve 360, an intervention solution outlet 370, and an intervention solution concentrate container 380. The water inlet 310 may be configured to connect to a residential or commercial water supply line, such as, a public water supply, a well water supply, or the like.

The filter 320 may be configured to remove substantially all impurities in the water supplied from the water inlet 310. The filter 320 may include, for example, a 200 mesh filter/80 micron filter, a reverse osmosis filter, or the like.

The pressure regulator 330 may be configured to regulate the pressure of the filtered water received from the filter 320. The pressure regulator 330 may supply the filtered water to the flow restrictor 320 at a substantially constant pressure.

The flow restrictor 320 may restrict the flow of the water from the pressure regulator 330 to the mixer 350, thereby ensuring that fluid does not flow from the mixer 350 to the pressure regulator 330.

The mixer 350 may include, for example, a Dosatron® metering head, a multi-channel mixing pump system, a Venturi and mixing pump system, or the like. The mixer 350 is configured to receive the water from the flow restrictor 320 and draw an intervention solution from the container 380 via a concentrate supply line 385. The mixer 350 then mixes the water with the intervention solution contrite obtained from the container 380 to generate a blended intervention solution, which is output at the outlet 370 via the check valve 360. The mixer 350 may be driven by the water supplied from the water inlet 310.

The intervention solution concentrate provided in, for example, the container 380 (shown in FIG. 6) may include any one or more of the major branded intervention products, including, for example: Beefxide®, which is a lactic acid and citric acid blended concentrate; Aftec™ distributed by Solution Bio Sciences™, which uses buffered sulfuric acid (H₂SO₄) as an active ingredient; HB2™ made by Enviro Tech™, which uses hydro-bromic acid as an active ingredient; Perasan MP™ distributed by Solution Bio Sciences, which is a peracetic acid based product; Keeper®, which is an acidified sodium chloride (ASC) product that is marketed by Dan Mar™ and made by Biocide International™; Cecure® made by Safe Foods™, which includes cetylpyridium chloride as an active ingredient; Citrilow® made by Safe Foods™, which is an organic acid based product; Syntryx 3300® made by Synergy Technologies™, which is an organic acid based product; AvGard XP™ from Danisco®, which is a sodium metasilicate based “basic pH” product; CytoGuard™ made by A&B Ingredients™, which is a lauric arginate based product that gets blended with another organic acid based intervention concentrate when used commercially; Sanova® by Ecolab®, which is an ASC and citric acid blended product; Inspexx™ by Ecolab®, which includes pero-acetic acid. The intervention solution concentrate may alternatively (or additionally) include generic lactic acid, generic peracetic and acetic acids, generic acidified sodium chloride (ASC), or the like.

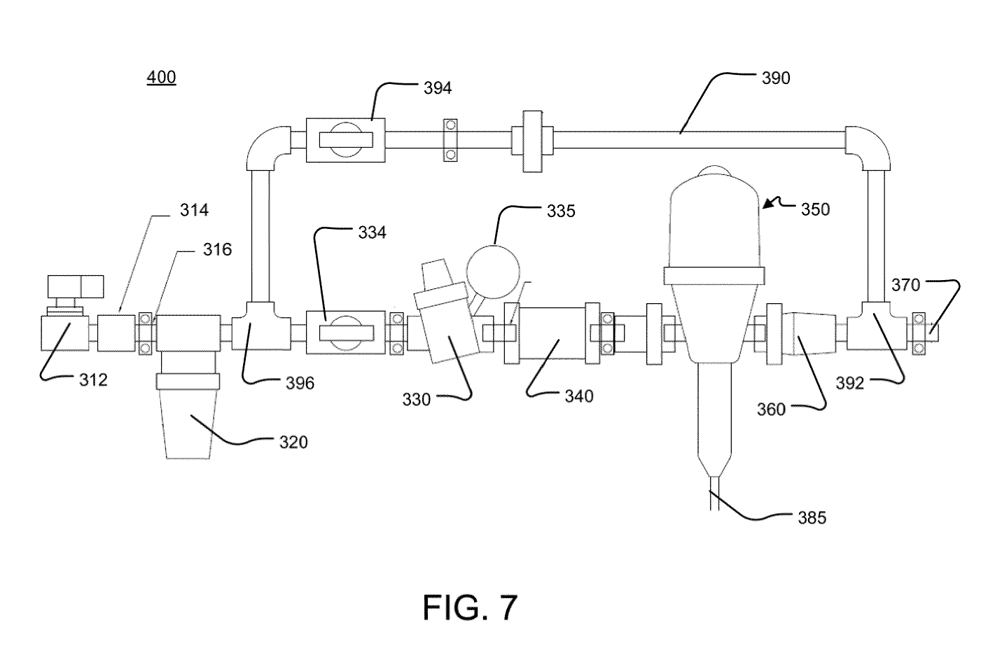

FIG. 7 shows another example of a mixing system 400, which is constructed according to the principles of the disclosure. Further to the description provide above with regard to FIG. 6, the mixing system 400 may include a valve 312, an optional anti-syphon 314, a plurality of connectors 316, a valve 334, a pressure monitor 335, a bypass line 390, and a plurality of T-connectors 392, 396. The valves 312, 334, 394 may include, for example, a manual valve, a solenoid valve, a ball valve, a needle valve, or the like. The pressure monitor 335 may include a pressure sensor (not shown) and a pressure display (for example, an analog display, a digital display, or the like). The valve 312 may be configured to control the flow of water into mixing system 400. The valves 334, 394 may be actuated to stop the flow of water into the regulator 330 and allow the water to flow through the bypass line 390 to the intervention solution outlet 370, thereby bypassing the mixer 350 entirely. The valves 334, 394 may be further implemented to controllably modify the strength of the intervention solution output at the intervention solution outlet 370 by affecting the rate of flow of the water into the bypass line 390 with regard to the rate of flow of the water into the mixer 350.

The mixing system (for example, mixing systems 300 or 400, shown in FIGS. 6, 7) may be extended to feed more than one intervention system (for example, intervention system 200, shown in FIG. 5) in food conditioners or as a standalone appliance on demand, should the mixing system capacity be adequate to do so. In this regard, about a 10% capacity reserve over the sum of dispense rates of the multiple applicators may be adequate. Further, the intervention system may be extended to feed more than one application system (for example, intervention solution application system 100, shown in FIG. 2).

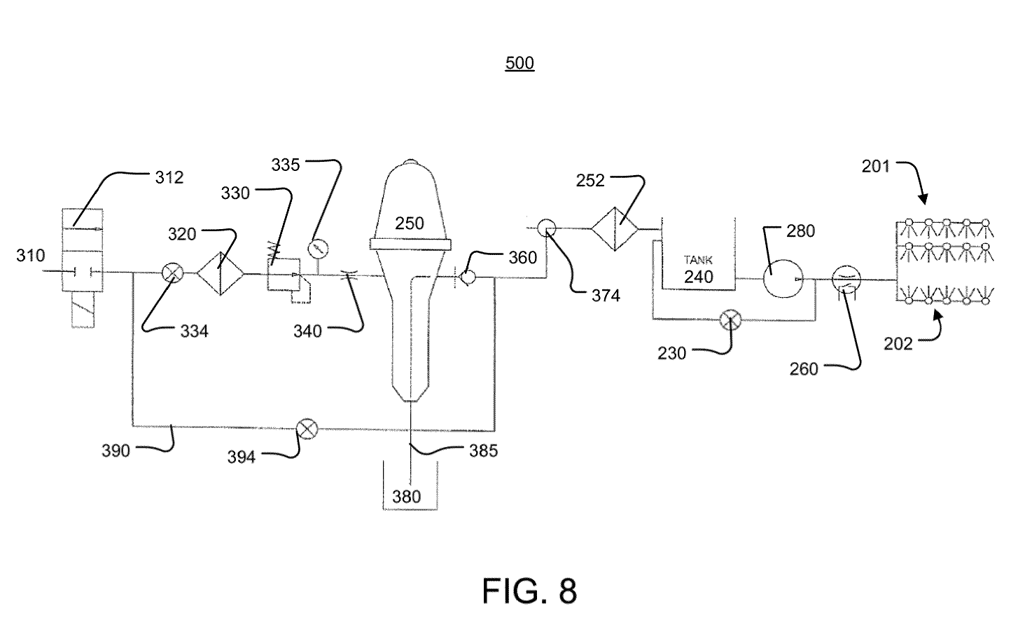

FIG. 8 shows an example of an integral intervention system 500, which is constructed according to the principles of the disclosure. Further to description provided above, the integral intervention system 500 includes the mixing system 400 (shown in FIG. 7), or a substantial portion thereof, and a substantial portion of the intervention system 200 (shown in FIG. 5). The integral intervention system 500 may further include a filter 252, and a 3-way valve 374. The filter 252 may include, for example, a 22 micron filter. The 3-way valve 374 may be coupled to the intervention solution output 370 at one inlet and a sample at the other inlet.

The integral intervention system 500 may further include a bypass line (not shown) that bypasses the tank 240 and the pump 280 under the control of an internal switch (not shown) to modify the fluid flow path of the intervention solution from the source supply 250 to the line 212 (shown in FIG. 5).

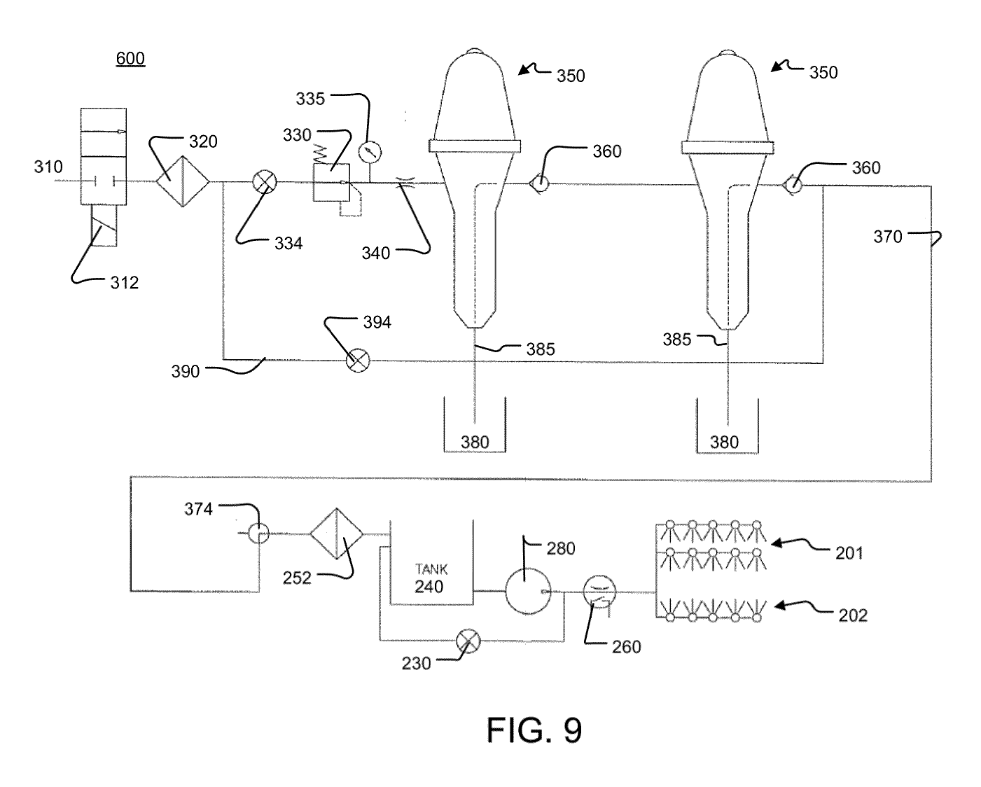

FIG. 9 shows another example of an integral intervention system 600, which is constructed according to the principles of the disclosure. Further to the description provided above with regard to FIG. 8, the integral intervention system 600 includes a second mixer 350 and a second check valve 360. The output from the first mixer 350 is coupled to the input of the second mixer 350. As seen in FIGS. 8 and 9, the filter 320 may be positioned either before or after the bypass line 390.

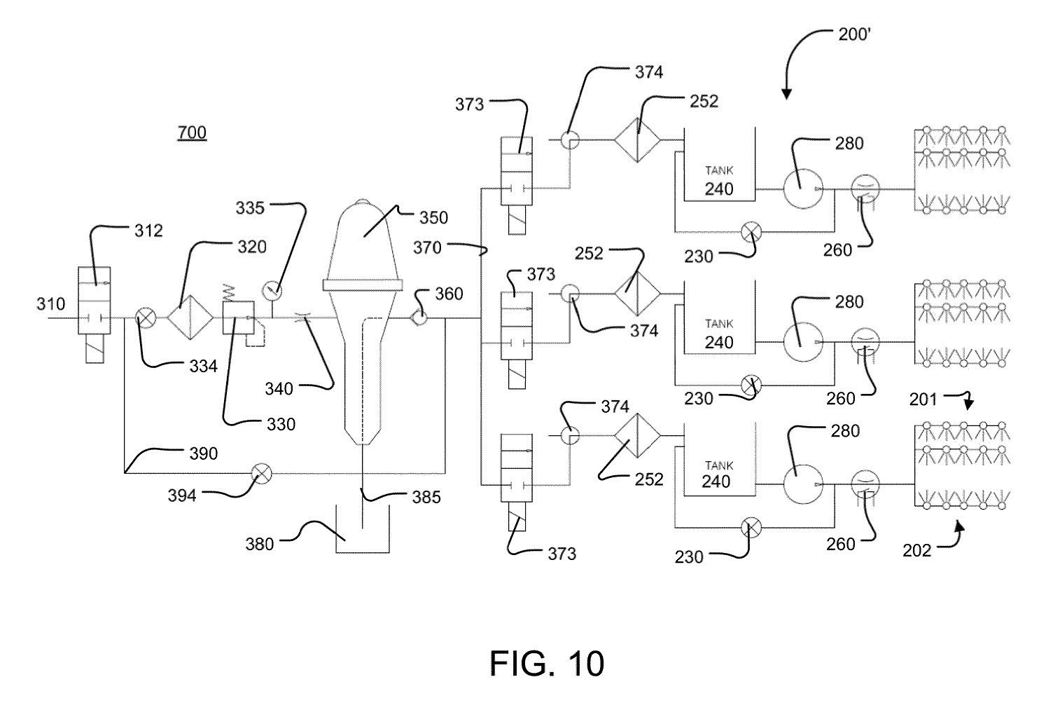

FIG. 10 shows yet another example of an integral intervention system 700, which is constructed according to the principles of the disclosure. Further to the description provided above with regard to FIG. 8, the integral intervention system 700 may include a plurality of parallel intervention systems 200′. Each of the intervention systems 200′ may be connected to the intervention solution outlet 370 via a respective valve 373. The valve 373 may include, for example, a manual valve, a solenoid valve, a ball valve, a needle valve, or the like. Through actuation of the valves 373 (for example, ON, OFF, or partial ON), the intervention systems 200′ may be controlled to treat multiple zones of a processing chamber (not shown, for example, in the food product processor 30, shown in FIG. 1), or to control the amount of intervention solution simultaneously applied in the processing chamber for a synergistic (or blended) intervention solution of the proper strength. For instance, the intervention systems 200′ may be operated sequentially as a food product is carried by the conveyor 70 (shown in FIG. 2) through the processing chamber to sequentially treat the food product, thereby treating the entire surface of the food product.

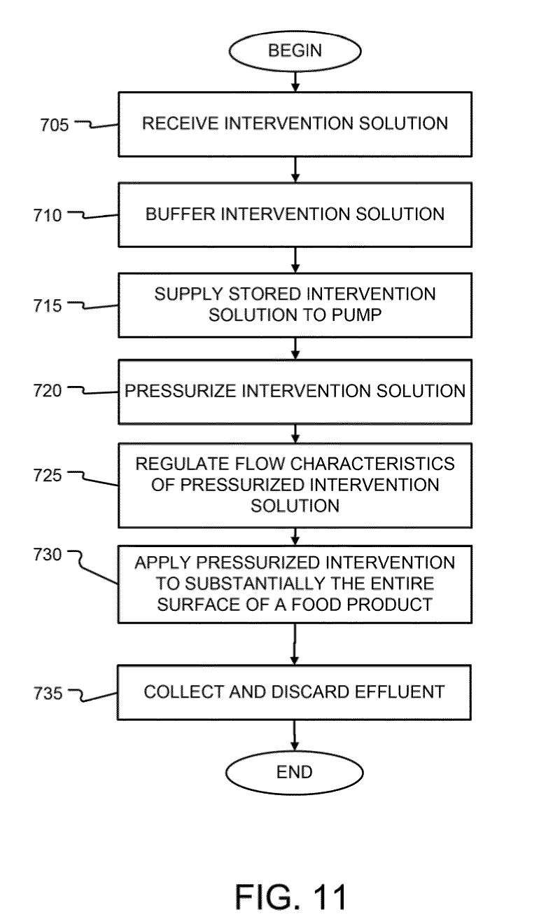

FIG. 11 shows an example of a process for applying an intervention solution to a food product. Referring to FIGS. 5 and 7, an intervention solution may be received at the tank 240 from a mixing system (for example, mixing system 300 shown in FIG. 6) (Step 705). The intervention solution may be buffered (or stored) in the tank 240 to ensure an adequate supply of the intervention solution in the intervention system 200 during application of the intervention solution to the food product (Step 710). The amount of intervention solution in the tank 240 may monitored by the level sensor 245 and kept within a predetermined range of acceptable levels.

The intervention solution may be supplied from the tank 240 to the pump 280, which is configured to pressurize the intervention solution and supply the pressurized intervention solution to the applicators 201, 202 (Step 720). The flow rate and the amount of pressurized intervention solution supplied to the applicators may be monitored and regulated by the flow monitor 260 (Step 725). The regulated pressurized intervention solution may then be supplied to the applicators 201, 202 which eject the solution on substantially the entire surface of the food product (Step 730). The effluent from the intervention treatment of the food product is collected and discarded (Step 735).

According to an aspect of the disclosure, a computer readable medium is disclosed that may embody a computer program which includes a plurality of sections (or segments) of code (or instructions) that, when executed on a computer (for example, the controller 290 in FIG. 5), cause the processes of Steps 705 to 735 to be carried out. The computer program may include a section of code for each of the Steps 705 to 735.

According to a further example of the disclosure, the controller 290 (shown in FIG. 5), which may include a computer, may communicate with a network (not shown) via a communication link (not shown) for remote monitoring and control of the intervention system 200 and the mixing system 300. The controller 290 may be connected to and configured to actuate the valves 220, 230, 270, the pump 280 and the flow monitor 290. For instance, the controller 290 may control the amount of pressurized intervention solution released from the applicator 202 compared to the amount of pressurized intervention solution released from the applicator 201 by controlling the balance valve 220 to obtain a recommended application amount of the intervention solution on the food product (for example, between about 0.75 oz/lb and about 1.5 oz/lb). The controller 290 may control the supply of intervention solution from the tank 240 to the pump 280 by controlling the shut off valve 270. The controller 290 may bypass the actuators 201, 202 and supply the pressurized intervention solution from the pump 280 to the tank 240 by controlling the bypass valve 230. The controller 290 may determine and control the rate of flow and the amount of intervention solution applied by the applicators 201, 202 by monitoring and controlling the flow monitor 260 (for example, between about 15 sec. and about 20 sec. of fresh spray time, and a total amount of intervention solution between about 0.75 oz/lb and about 1.5 oz/lb). In this regard, the controller 290 may also monitor and control the pump 280, as well as monitor the amount of intervention solution in the tank 240 via the sensor 245. The controller 290 may be further connected to the mixer 350.

In the further example of the disclosure, the controller 290 may include a look-up-table (LUT) that includes optimum treatment parameters for the particular intervention solution to be used in a particular treatment process, as well as the concentration of each active ingredient in the intervention solution for a given food product. For example, the LUT may specify that: the recommend active concentration for lactic acid (C₃H₆O₃) is between about 2% and about 5% of total solution, such as, for example, about 2.6%; the recommended amount of anti-microbial product sprayed on a food product is between about 0.75 ounces (oz) and about 1.5 oz (for example, about 1 oz/lb) for every pound of the food product that is to be treated; and, the recommended amount of spray time is between about 15 seconds and about 20 seconds of fresh spray time. The LUT may specify that an intervention solution comprising acidified sodium chloride (ASC) should be applied at a temperature of about 34° F., or at a temperature of at least 52° F. to minimize any handling risks. The LUT may also specify that the food conditioner 10 must include an approved exhaust system (not shown) to vent the chlorine dioxide gas that may be a byproduct of using an intervention solution. Meanwhile, the LUT may specify that an approved exhaust system is not necessary where the intervention solution consists of lactic acid, peroxy-acetic or acetic acid.

The LUT may be embodied in a computer readable medium, which may be loaded into the controller 290, or used to update the LUT in the controller 290 to provide for optimum intervention solution treatment of food products.

According to a further aspect of the disclosure, a product flow switch (not shown) may be included in the food conditioner 10 (shown in FIG. 1). The product flow switch, which may be controlled by the controller 290 and a food product sensor, may make the food conditioner 10 more efficient by conserving the intervention solution (including, for example, antimicrobial fluid), by stopping the system spray if the food product stream flow is interrupted without requiring any operator or attendant action. The no flow switch interlock may help satisfy plant or facility HACCP plans by ensuring no food product is packed out that hasn't been treated with the intervention solution, since the system can only operate when, for example, the positive displacement pump is in operation, and delivering an adequate fluid flow rate to cover the external surface area of the food products that run through food conditioner 10.

Using the principles of the present disclosure, food borne illnesses may be minimized by effectively spraying an anti-microbial intervention solution on the entire surface of a food product, thereby killing most of the pathogens on the surface of food product. This process may be affective with, for example, 15 seconds of fresh spray application or residence time. The process minimizes cross-contamination between processed food products.

Since antimicrobial surface treatments do not generally affect the taste of cooked food products, the process disclosed herein provides an effective methodology for substantially eliminating pathogens on the surface of food products, without noticeably affecting the taste of the food products.

While the disclosure has been described with regard to an intervention solution that is primarily in liquid form, it is noted that the intervention solution may be entirely in liquid or gas form, or a combination of liquid and gas. In the case where the intervention solution is substantially in gas form (such as, for example, ozone, hydrogen peroxide, or the like, or any combination of the foregoing), the components described herein may be modified as will be understood by those having ordinary skill in the art.

While the disclosure has been described in terms of exemplary embodiments, those skilled in the art will recognize that the disclosure can be practiced with modifications in the spirit and scope of the appended claim, drawings and attachment. The examples provided herein are merely illustrative and are not meant to be an exhaustive list of all possible designs, embodiments, applications or modifications of the disclosure.

For instance, as noted earlier, the various examples of the disclosure described herein may be implemented in a slicer, or as a standalone applicator for intact meat, poultry, fruit, vegetables, or other fresh food products to enhance their shelf life or to reduce the risk of food borne illness.

What is claimed:

1. An intervention system for treating a food product in a food conditioner, the system comprising:
a tank that receives and buffers an intervention solution from a mixing system;
a pump that receives the intervention solution from the tank and pressurizes the intervention solution to output a pressurized intervention solution;
a flow monitor that receives the pressurized intervention solution from the pump and monitors a predetermined characteristic of the pressurized intervention solution;
a first applicator that receives a first portion of the pressurized intervention solution from the flow monitor and ejects a first mist in the direction of the food product; and
a second applicator that receives a second portion of the pressurized intervention solution from the flow monitor and ejects a second mist in the direction of the food product.

2. The system according to claim 1, further comprising a balance valve that controls a rate of ejection of the second portion of the pressurized intervention solution with regard to a rate of ejection of the first portion of the pressurized intervention solution, thereby balancing treatment of the food product by the first mist and the second mist to substantially fully coat an external surface area of the food product.

3. The system according to claim 1, wherein the predetermined characteristic comprises a rate of flow of the pressurized intervention solution.

4. The system according to claim 1, wherein the pump comprises at least one of:
a positive displacement pump;
an electric Santoprene™ diaphragm pump; or
an air-operated twin diaphragm pump.

5. The system according to claim 1, the system further comprising:
a level sensor that monitors a level of the intervention solution in the tank.

6. The system according to claim 1, wherein the first applicator comprises:
a nozzle that ejects the first mist in the direction of the food product; and
a first supply line that supplies the intervention solution to the nozzle that ejects the first mist.

7. The system according to claim 1, wherein the second applicator comprises:
a nozzle that ejects the second mist in the direction of the food product; and
a supply line that supplies the intervention solution to the nozzle that ejects the second mist.

8. The system according to claim 6, wherein the first applicator further comprises:
another nozzle that ejects another mist in the direction of the food product;
a further nozzle that ejects a further mist in the direction of the food product; and
a second supply line that supplies the intervention solution to said another nozzle.

9. The system according to claim 8, wherein the first mist, the second mist, said another mist, and said further mist are configured to overlap and collectively form a spray curtain that substantially envelopes the food product and substantially contain any overspray within a processing chamber of the food conditioner.

10. The system according to claim 8, wherein:
said nozzle is affixed to said first supply line;
said another nozzle is affixed to said second supply line; and
said first supply line is substantially parallel to said second supply line.

11. The system according to claim 7, wherein the second applicator comprises:
another nozzle that ejects another mist in the direction of the food product; and
a further nozzle that ejects a further mist in the direction of the food product,
wherein said nozzle, said another nozzle, and said further nozzle are configured such that said second mist, said another mist, and said further mist are offset from each other.

12. A food conditioner that comprises the intervention system according to claim 1, wherein the food conditioner comprises:
a meat tenderizer;
a cuber;
a tender press;
a rinser;
a washer;
a slicer; or
an injector.

13. An intervention system for a food conditioner, the system comprising:
a first applicator that is configured to apply a pressurized intervention solution to a first surface area of a food product;
a second applicator that is configured to apply the pressurized intervention solution to a second surface area of the food product,
wherein an entire surface area of the food product substantially consists of the first surface area and the second surface area.

14. The system according to claim 13, wherein the first applicator comprises:
a nozzle that ejects a first mist in the direction of the first area of the food product; and
a first supply line that supplies the intervention solution to the nozzle that ejects the first mist.

15. The system according to claim 13, wherein the second applicator comprises:
a nozzle that ejects a second mist in the direction of the second surface area of the food product; and
a supply line that supplies the intervention solution to the nozzle that ejects the second mist.

16. The system according to claim 14, wherein the first applicator further comprises:
another nozzle that ejects another mist in the direction of the food product; and
a second supply line that supplies the intervention solution to said another nozzle.

17. The system according to claim 16, wherein:
said nozzle is affixed to said first supply line;
said another nozzle is affixed to said second supply line; and
said first supply line is substantially parallel to said second supply line.

18. The system according to claim 13, further comprising:
a pump that pressurizes an intervention solution to generate the pressurized intervention solution.

19. The system according to claim 18, further comprising:
a tank that receives and buffers the intervention solution from a mixing system before supplying a buffered intervention solution to the pump.

20. The system according to claim 15, wherein the second applicator comprises:
another nozzle that ejects another mist in the direction of the food product; and
a further nozzle that ejects a further mist in the direction of the food product,
wherein said nozzle, said another nozzle, and said further nozzle are configured such that said second mist, said another mist, and said further mist are offset from each other.

21. A method for treating a food product, the method comprising:
receiving an intervention solution;
buffering the received intervention solution to output a buffered intervention solution;
pressurizing the buffered intervention solution to output a pressurized intervention solution;
applying the pressurized intervention solution to the food product;
collecting an effluent from the food product; and
discarding substantially all of the effluent.

22. The method according to claim 21, wherein the intervention solution includes a blended intervention solution that is received from a central mixing system which in-line mixes a plurality of intervention solution concentrates with water to generate the blended intervention solution.

23. The method according to claim 21, further comprising:
stopping the application of the pressurized intervention solution when a food product flow interruption is detected.
